(19) United States
(12) Patent Application Publication
(10) Pub. No.: US 2023/0235192 A1
(43) Pub. Date: Jul. 27, 2023

(54) UV-LED CURABLE AND YELLOWING RESISTANT COATING COMPOSITION

(71) Applicant: GUANGDONG HUARUN PAINTS CO., LTD, Foshan City (CN)

(72) Inventors: Yijiang LIU, Foshan City (CN); Qiongbo WANG, Foshan City (CN); Wei YANG, Shanghai (CN)

(21) Appl. No.: 18/001,633

(22) PCT Filed: Jul. 19, 2021
(86) PCT No.: PCT/CN2021/107210

§ 371 Date: Dec. 13, 2022

(30) Foreign Application Priority Data
Jul. 17, 2020 (CN) 202010690319.7

(51) Int. Cl. C09D 133/10; C09D 7/63

(52) U.S. Cl. CPC C09D 133/10; C09D 7/63

(57) ABSTRACT

The present application relates to a UV-LED curable coating composition, including: (a) at least one amine-modified polyether acrylate; (b) at least one (meth)acrylate polymer different from (a); (c) at least one multifunctional thiol compound; and (d) at least one acylphosphine oxide as a photoinitiator. In addition, the present application further relates to an article including a substrate partially or fully coated with the UV-LED curable coating composition.

### BACKROUND OF THE INVENTION

The present application claims priority from Chinese Patent Application No. 202010690319.7, filed on Jul. 17, 2020, which is incorporated herein by reference to its entirety.

### TECHNICAL FIELD

The present application relates to a UV-LED curable coating composition, and also relates to an article containing the UV-LED curable coating composition.

### BACKGROUND

Ultraviolet curing technology (UV) has the advantages of environmental protection, energy saving, fast curing, and controllable curing. It has achieved rapid development in the past 20 years and has been widely used in coatings, inks, adhesives, microelectronic materials and other fields. Compared with the high-energy UV curing technology using conventional mercury lamps, UV-LED has the advantages of low energy consumption, convenient carrying and long service life, so UV-LED curing has received extensive attention in recent years.

Because the curing light source has a single wavelength (usually initiated by a single wavelength of 395 nm), conventional UV-LED curable coatings have serious oxygen inhibition when the coating is thinner, which is manifested by poor surface dryness of the coating and low surface strength of the coating. Thus it can only be used as a primer, which greatly limits the application of UV-LED curable coatings. Although the thioxanthone-based photoinitiator is of great help to the surface drying of the coating which is cured at a wavelength of 395 nm, the yellowing of the coating is serious, and the hard and brittle adhesion of the coating decreases after curing, thus the application is also greatly restricted.

Therefore, in the coating industry, there is still a need for UV-LED curable coating compositions that have both yellowing resistance and high curing rate.

### SUMMARY

The present application provides a UV-LED curable coating composition, including:
(a) at least one amine-modified polyether acrylate;
(b) at least one (meth)acrylate polymer different from (a);
(c) at least one multifunctional thiol compound; and
(d) at least one acylphosphine oxide as a photoinitiator.

In the embodiments according to the present application, the at least one multifunctional thiol compound contains at least three mercapto groups.

In the embodiments according to the present application, the coating composition further includes a co-initiator, wherein the co-initiator includes alkylhydroxylamines, dimethylaminobenzoates amine modified acrylate monomers or prepolymers, or combinations thereof.

According to another aspect of the present application, a UV-LED curable coating composition is provided, wherein, with respect to the total weight of the coating composition, the coating composition includes:
(a) 10-30% by weight of the at least one amine-modified polyether acrylate;
(b) 30-60% by weight of the at least one (meth)acrylate polymer different from (a);
(c) 0.5-2% by weight of the at least one multifunctional thiol compound;
(d) 3-6% by weight of the at least one acylphosphine oxide;
(e) 15-30% by weight of at least one reactive diluent;
(f) 0.5-2% by weight of at least one co-initiator; and
(g) 0.1-1% by weight of at least one additional additive comprising a thickener, a surfactant, a defoamer, a bactericide, or any combination thereof.

According to another aspect of the present application, the color difference value ΔE of the coating formed by curing the coating composition on a BYK white coating film test cardboard with the BYK white coating film test cardboard is less than 2.0.

According to another aspect of the present application, an article including a substrate partially or fully coated with a UV-LED curable coating composition according to the present application is provided.

In the present application, the applicant uses a combination of a specific multifunctional thiol compound and a specific amine-modified polyether acrylate. In addition to inhibiting the surface oxygen inhibition, the “click” chemical reaction of the mercapto group and the double bond can be used to increase the crosslinking degree of cross-linking of coating, thus the performance of the coating is improved and the thiol is locked in the coating to prevent the thiol from migrating to the surface and causing odors to escape. On this basis, by adjusting the combination of film-forming resin and initiator, avoiding the use of yellowing initiator, while ensuring the apparent effect of the coating, the co-initiator can be used to further improve the curing reaction efficiency, reduce the required curing energy and realize fast curing.

The details of one or more embodiments of the disclosure are set forth in the following description. Other features, objects, and advantages of the disclosure will be apparent from the description and from the claims.

### Selected Definitions

As used herein, “a”, “an”, “the”, “at least one”, and “one or more” are used interchangeably, unless indicated otherwise. Thus, for example, a coating composition that comprises “an” additive can be interpreted to mean that the coating composition includes “one or more” additives.

As used herein, “acrylate” is the general term for esters of acrylic acid and its homologs, such as methyl acrylate, ethyl acrylate, methyl 2-methacrylate, ethyl 2-methacrylate, and the like. Therefore, unless otherwise indicated, “acrylate” includes both acrylate and methacrylate.

Throughout the present disclosure, where compositions are described as having, including, or comprising specific components or fractions, or where processes are described as having, including, or comprising specific process steps, it is contemplated that the compositions or processes as disclosed herein may further comprise other components or fractions or steps, whether or not specifically mentioned in this disclosure, as long as such components or steps do not affect the basic and novel characteristics of the invention, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, ranges from any lower limit may be combined with any other lower limit to recite a range not explicitly recited, and in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

In the context of the present invention, “multifunctional thiol compound” refers to a polythiol compound containing 2 or more mercapto groups in the molecule. The chemical formula of the mercapto group is —SH, which is a negative monovalent functional group composed of a sulfur atom and a hydrogen atom connected together.

When appearing in this specification and claims, the terms “comprising” and “including” and variations thereof do not have a restrictive meaning.

The terms “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

### DETAILED DESCRIPTION

In an aspect, the present application provides a UV-LED curable coating composition, comprising:
(a) at least one amine-modified polyether acrylate;
(b) at least one (meth)acrylate polymer different from (a);
(c) at least one multifunctional thiol compound; and
(d) at least one acylphosphine oxide as a photoinitiator.

(a) Amine-Modified Polyether Acrylate

In the coating composition according the embodiments of the present application, the amine-modified polyether acrylate as the film-forming resin is obtained by amine modification on the basis of a polyether acrylate with a high degree of esterification and a low viscosity. After amine modification, the curing rate of the polyether acrylate is high, and the curing shrinkage rate is significantly reduced, while still having a relatively low viscosity. The amine-modified polyether acrylate provided by the present application can effectively reduce odor and reduce amine migration, and has the characteristics of low yellowing.

Amine-modified polyether acrylate is a resin commonly used in this field, for example, as PO 83F, PO 94F, LR8869 and/or LR8889 available from BASF.

Based on the total weight of the UV-LED curable coating composition, the amine-modified polyether acrylate is present in an amount of 10 to 40% by weight, preferably in an amount of 10 to 30% by weight, more preferably in an amount of 15 to 30% by weight.

(b) (Meth)acrylate Polymer Different From (a)

The UV-LED curable coating composition according to the embodiments of the present application further comprises a (meth)acrylate polymer different from the above-mentioned amine-modified polyether acrylate as a film-forming resin.

The (meth)acrylate polymer other than amine-modified polyether acrylate comprises at least one of epoxy (meth)acrylate, polyurethane (meth)acrylate, polyester (meth)acrylate, polyether (meth)acrylate, and acrylate copolymer.

The epoxy (meth)acrylate polymer is an addition product of the reaction of epoxy resin and unsaturated carboxylic acid (for example, acrylic acid, methacrylic acid), including the epoxy (meth)acrylate of bisphenol A epoxy resin, epoxy (meth)acrylate or diglycidyl ether (meth)acrylate of phenol or cresol-novolac epoxy resin.

The polyurethane (meth)acrylate polymer is a reaction product prepared by reacting a hydroxyl-containing (meth)acrylate with a reaction product of a polyol and an organic polyisocyanate. The hydroxyl-containing (meth)acrylate is a hydroxyalkyl (meth)acrylate, such as 2-hydroxyethyl (meth)acrylate or 2-hydroxypropyl (meth)acrylate. The polyol includes ethylene glycol, propylene glycol or butylene glycol and the like. The organic polyisocyanate includes toluene diisocyanate, 4,4′-diphenylmethane diisocyanate, 4,4′-dicyclohexylmethane diisocyanate, hexamethylene diisocyanate or isophorone diisocyanate.

The polyester (meth)acrylate polymer is a dehydration condensation product of polyester polyol and (meth)acrylic acid. The polyester polyol is a reaction product of a polyol and a dibasic acid, wherein the polyol includes ethylene glycol, polypropylene glycol, 1,6-hexanediol, or trimethylolpropane, etc., and the dibasic acid includes adipic acid, succinic acid, phthalic acid, hexahydrophthalic acid or terephthalic acid, etc.

The polyether (meth)acrylate polymer is a polyalkyl glycol di(meth)acrylate, such as polyethylene glycol di(meth)acrylate or polypropylene glycol di(meth)acrylate.

The acrylate copolymer is a polymer obtained from the monomers such as (meth)acrylic acid, (meth)acrylate, styrene, etc., under the action of a peroxide initiator (for example, benzoyl peroxide), by free radical polymerization.

Based on the total weight of the UV-LED curable coating composition, the (meth)acrylate polymer other than the amine-modified polyether acrylate is present in an amount of 30 to 70% by weight, preferably in an amount 30 to 60% by weight, more preferably in an amount of 40 to 60% by weight.

(c) Multifunctional Thiol Compound

The multifunctional thiol compounds to be used in the present application are the polythiol compounds having 2 or more SH groups in its molecule. Polythiol compounds include aliphatic polythiol compounds, aromatic polythiol compounds, and the like.

Specifically, aliphatic polythiol compounds include dithiol compound such as 1,2-ethanedithiol, 1,2-propanedithiol, 1,3-propanedithiol, 1,4-butanedithiol, 1,6-hexanedithiol, 1,7-heptanedithiol, 1,8-octanedithiol, 1,9-nonanedithiol, 1,10-decanedithiol, 1,12-dodecanedithiol, 2,2-dimethyl-1,3-propanedithiol, 3-methyl-1,5-pentanedithiol, 2-methyl-1,8-octanedithiol, 1,4-cyclohexanedithiol, 1,4-bis(mercaptomethyl)cyclohexane, 1,1-cyclohexanedithiol, 1,2-cyclohexanedithiol, bicyclo[2,2,1]hept-exo-cis-2,3-dithiol, 1,1-bis(mercaptomethyl)cyclohexane, bis(2-mercaptoethyl)ether, ethylene glycol bis(2-mercaptoacetate) and ethylene glycol bis(3-mercaptopropionate); trithiol compound such as 1,1,1-tris(mercaptomethyl)ethane, 2-ethyl-2-mercaptomethyl-1,3-propanedithiol, 1,2,3-propanetrithiol, trimethylolpropane tris(2-mercaptoacetate), trimethylolpropane tris(3-mercaptopropionate) and tris((mercaptopropionyloxy)-ethyl)isocyanurate; and thiol compound having 4 or more SH groups such as pentaerythritol tetrakis(2-mercaptoacetate), pentaerythritol tetrakis(3-mercaptopropionate), pentaerythritol tetrakis(3-mercaptobutanate) and dipentaerythritol hex-3-mercaptopropionate.

Furthermore, aromatic polythiol compounds include 1,2-dimercaptobenzene, 1,3-dimercaptobenzene, 1,4-dimercaptobenzene, 1,2-bis(mercaptomethyl)benzene, 1,3-bis(mercaptomethyl)benzene, 1,4-bis(mercaptomethyl)benzene, 1,2-bis(2-mercaptoethyl)benzene, 1,3-bis(2-mercaptoethyl)benzene, 1,4-bis(2-mercaptoethyl)benzene, 1,2-bis(2-mercaptoethyleneoxy)benzene, 1,3-bis(2-mercaptoethyleneoxy)benzene, 1,4-bis(2-mercaptoethyleneoxy)benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(2-mercaptoethyl)benzene, 1,2,4-tris(2-mercaptoethyl)benzene, 1,3,5-tris(2-mercaptoethyl)benzene, 1,2,3-tris(2-mercaptoethyleneoxy)benzene, 1,2,4-tris(2-mercaptoethyleneoxy)benzene, 1,3,5-tris(2-mercaptoethyleneoxy)benzene, 1,2,3,4-tetramercaptobenzene, 1,2,3,5-tetramercaptobenzene, 1,2,4,5-tetramercaptobenzene, 1,2,3,4-tetrakis(mercaptomethyl)benzene, 1,2,3,5-tetrakis(mercaptomethyl)benzene, 1,2,4,5-tetrakis(mercaptomethyl)benzene, 1,2,3,4-tetrakis(2-mercaptoethyl)benzene, 1,2,3,5-tetrakis(2-mercaptoethyl)benzene, 1,2,4,5-tetrakis(2-mercaptoethyl)benzene, 1,2,3,4-tetrakis(2-mercaptoethyleneoxy)benzene, 1,2,3,5-tetrakis(2-mercaptoethyleneoxy)benzene, 1,2,4,5-tetrakis(2-mercaptoethyleneoxy)benzene, 2,2′-dimercaptobiphenyl, 4,4′-thiobis-benzenethiol, 4,4′-dimercaptobiphenyl, 4,4′-dimercaptobibenzyl, 2,5-toluenedithiol, 3,4-toluenedithiol, 1,4-naphthalenedithiol, 1,5-naphthalenedithiol, 2,6-naphthalenedithiol, 2,7-naphthalenedithiol, 2,4-dimethylbenzene-1,3-dithiol, 4,5-dimethylbenzene-1,3-dithiol, 9,10-anthracenedimethanethiol, 1,3-bis(2-mercaptoethylthio)benzene, 1,4-bis(2-mercaptoethylthio)benzene, 1,2-bis(2-mercaptoethylthiomethyl)benzene, 1,3-bis(2-mercaptoethylthiomethyl)benzene, 1,4-bis(2-mercaptoethylthiomethyl)benzene, 1,2,3-tris(2-mercaptoethylthio)benzene, 1,2,4-tris(2-mercaptoethylthio)benzene, 1,3,5-tris(2-mercaptoethylthio)benzene, 1,2,3,4-tetrakis(2-mercaptoethylthio)benzene, 1,2,3,5-tetrakis(2-mercaptoethylthio)benzene, 1,2,4,5-tetrakis(2-mercaptoethylthio)benzene and the like.

Furthermore, the multifunctional thiol compounds having sulfide bond in their molecules include bis(2-mercaptoethyl)sulfide, bis(2-mercaptoethylthio)methane, 1,2-bis(2-mercaptoethylthio)ethane, 1,3-bis(2-mercaptoethylthio)propane, 1,2,3-tris(2-mercaptoethylthio)propane, tetrakis(2-mercaptoethylthiomethyl)methane, 1,2-bis(2-mercaptoethylthio)propanethiol, 2,5-dimercapto-1,4-dithiane, bis(2-mercaptoethyl)sulfide, 3,4-thiophenedithiol, 1,2-bis(2-mercaptoethyl)thio-3-mercaptopropane, bis-(2-mercaptoethylthio-3-mercaptopropane)sulfi de and the like.

Particularly preferable multifunctional thiol compounds are trivalent (having 3 or more SH groups) or more (generally, about octavalent or less) aliphatic polythiols, and particularly preferred is trimethylolpropane tris(2-mercaptoacetate), trimethylolpropane tris(3-mercaptopropionate), tris((mercaptopropionyloxy)-ethyl)isocyanurate, pentaerythritol tetrakis(2-mercaptoacetate), pentaerythritol tetrakis(3-mercaptopropionate), pentaerythritol tetrakis(3-mercaptobutanate), dipentaerythritol hex-3-mercaptopropionate and the like.

In the composition according to the present application, it is preferable that at least a portion of the multifunctional thiol compounds to be contained are trivalent or more (generally, about octavalent or less) polythiol compounds, and the entire multifunctional thiol compounds to be contained may be trivalent or more polythiol compounds.

In an embodiment according to the present invention, the multifunctional thiol compound contains 3 or more mercapto groups, preferably 4 or more mercapto groups.

Based on the total weight of the UV-LED curable coating composition, the multifunctional thiol compound is present in an amount of 0.5 to 4% by weight, preferably in an amount of 0.5 to 3% by weight, more preferably in an amount of 0.5 to 2% by weight.

(d) Acylphosphine Oxide

In an embodiment according to the present application, the coating composition contains an acylphosphine oxide as a photoinitiator, which has significant absorption under LED light radiation with a wavelength in the range of 340-420 nm. As a typical split-type photoinitiator, the maximum absorption peak of acylphosphine oxide is in the range of 340-420 nm, which can effectively absorb the light radiated by the light-emitting diode LED.

The acylphosphine oxide comprises a monoacylphosphine oxide, a bisacylphosphine oxide, or the combination thereof. The diacylphosphine oxide may be a compound of formula (I):

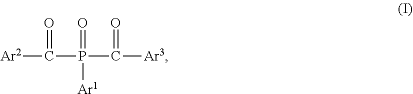

wherein each of Ar¹, Ar² and Ar³ is independently selected from a substituted or unsubstituted C6-C18 aryl group or a C1-C6 alkyl group.

The structure of the monoacylphosphine oxide is similar to that of the bisacylphosphine oxide, except that only one acyl group is directly linked to phosphorus. As an example, the monoacylphosphine oxide may be a compound of formula (II) (Lucirin TPO-L):

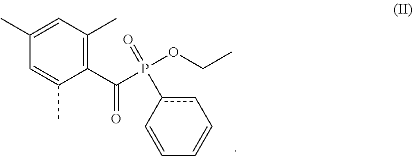

Acylphosphine oxides suitable for use in the present disclosure include, but are not limited to, 2,4,6-trimethylbenzoyl diphenylphosphine oxide (Lucirin TPO, commercially available from BASF), 2,4,6-trimethylbenzoyl phenyl ethoxy phosphine oxide (Lucirin TPO-L, commercially available from BASF), bis(2,4,6-trimethylbenzoyl)-phenylphosphineoxide (IRGACURE 819, commercially available from BASF) or any combination thereof.

At present, the most successful commercial acylphosphine oxide is IRGACURE 819 and Lucirin TPO, which are capable of absorbing UV light in the wavelength range of 385-410 nm.

Based on the total weight of the UV-LED curable coating composition, the acylphosphine oxide is present in an amount of 2 to 8% by weight, preferably in an amount of 3 to 8% by weight, more preferably in an amount of 3 to 6% by weight .

In addition, the UV-LED curable coating composition according to the present invention may further comprises a co-initiator. The co-initiator comprises alkylhydroxylamines, dimethylaminobenzoates, amine modified acrylate monomers or prepolymers, or combinations thereof

Examples of alkylhydroxyamines as co-initiators are triethanolamine, triisopropanolamine, methyldiethanolamine, and the like. Examples of dimethylaminobenzoates as co-initiators are 4-dimethylamino-ethyl benzoate or isooctyl 4-dimethylaminobenzoate, and the like.

The amine-modified acrylate monomer or prepolymer as a co-initiator is the reaction product obtained by the nucleophilic substitution reaction of an amine compound (for example, ethylenediamine) and an acrylate monomer or prepolymer (for example, trimethylolpropane triacrylate), including diethylamine modified trimethylolpropane triacrylate and the like.

Based on the total weight of the UV-LED curable coating composition, the co-initiator is present in an amount of 0 to 4% by weight, preferably in an amount of 0.5 to 3% by weight, more preferably in an amount of 0.5 to 2% by weigh.

The inventors found that the introduction of multifunctional thiol compounds in the coating composition can not only inhibit the surface oxygen inhibition, but also use the “click” chemical reaction of the mercapto group and the double bond to increase the crosslinking degree of the coating, thereby improving the performance of the coating and locking the thiol in the coating to prevent the thiol from migrating to the surface and causing odors to escape. On this basis, by selecting amine-modified polyether acrylate as the film-forming resin and acylphosphine oxide as the photoinitiator, the chemical stability of the acylphosphine oxide can be ensured, and the use of yellowing initiators can be avoided, which significantly improves the surface curing performance and yellowing resistance of the coating. The addition of a co-initiator further improves the reaction efficiency and reduces the required curing energy, thereby achieving fast curing.

In addition, the UV-LED curable coating composition according to the present invention may further comprises a reactive diluent. Reactive diluents can preferably be used for viscosity adjustment and/or physical property adjustment.

The reactive diluent comprises (meth)acrylic monomers. Monofunctional (meth)acrylic monomers include, for example, butanediol mono(meth)acrylate, cyclohexyl (meth)acrylate, dicyclopentanyl (meth)acrylate, dicyclopentenyl (meth)acrylate, dicyclopentenyloxyethyl (meth)acrylate, N,N-diethylaminoethyl (meth)acrylate, 2-ethoxyethyl (meth)acrylate, 2-hydroxyethyl (meth)acrylate, 2-hydroxypropyl (meth)acrylate, caprolactone-modified 2-hydroxyethyl (meth)acrylate, isobornyl (meth)acrylate, lauryl (meth)acrylate, acryloylmorpholine, N-vinylcaprolactam, nonylphenoxypolyethylene glycol (meth)acrylate, nonylphenoxypolypropylene glycol (meth)acrylate, phenoxyethyl (meth)acrylate, phenoxyhydroxypropyl (meth)acrylate, phenoxydiethylene glycol (meth)acrylate, polyethylene glycol (meth)acrylate, polypropylene glycol (meth)acrylate, tetrahydrofurfuryl (meth)acrylate and the like.

Polyfunctional (meth)acrylic monomers include, for example, 1,4-butanediol di(meth)acrylate, dicyclopentanyl di(meth)acrylate, ethylene glycol di(meth)acrylate, dipentaerythritol hexa(meth)acrylate, caprolactone-modified dipentaerythritol hexa(meth)acrylate, 1,6-hexanediol di(meth)acrylate, neopentyl glycol di(meth)acrylate, pentaerythritol tri(meth)acrylate, polyethylene glycol di(meth)acrylate, polypropylene glycol di(meth)acrylate, tetraethylene glycol di(meth)acrylate, trimethylolpropane tri(meth)acrylate, tris(acryloxyethyl)isocyanurate, caprolactone-modified tris(acryloxyethyl)isocyanurate, tris(methacryloxyethyl)isocyanurate, tricyclodecane dimethanol di(meth)acrylate and the like.

These monofunctional (meth)acrylic monomers and polyfunctional (meth)acrylic monomers may be used solely or in combination with 2 or more monomers, or may be used in combination with the monofunctional and polyfunctional monomers.

As a component used in combination, monofunctional (meth)acrylate compounds may be preferably used for viscosity adjustment and/or physical property adjustment. In a certain application, alicyclic (meth)acrylate compounds such as isobornyl acrylate are preferable.

In a preferred embodiment according to the present application, the reactive diluent is selected from at least one of dipropylene glycol di(meth)acrylate, dipentaerythritol hexa(meth)acrylate, dipentaerythritol penta(meth)acrylate, 1,6-hexanediol di(meth)acrylate, (ethoxylated) trimethylolpropane tri(meth)acrylate, (propoxylated) trimethylolpropane tri(meth)acrylate, pentaerythritol tri(meth)acrylate, pentaerythritol tetra(meth)acrylate, and isobornyl (meth)acrylate.

Based on the total weight of the UV-LED curable coating composition, the reactive diluent is present in an amount of 10 to 40% by weight, preferably in an amount of 10 to 30% by weight, more preferably in an amount of 15 to 20% by weight.

The UV-LED curable coating composition according to the present application may optionally comprise additional additives commonly used in coating composition, and these additives will not adversely affect the coating composition or the cured coating obtained therefrom. Suitable additives include, for example, those that can be used to improve the processability or manufacturability of the composition, enhance composition aesthetics, or improve a particular functional property or characteristic of the coating composition or the cured composition resulting therefrom, such as adhesion to a substrate. Suitable examples of the additive include, such as carriers, film forming auxiliaries, co-solvents, pigments, fillers, anti-migration aids, antibacterial agents, chain extenders, lubricants, wetting agents, biocides, plasticizers, antifoaming agent, coloring agent, wax, antioxidant, anticorrosive, flow control agent, thixotropic agent, dispersant, adhesion promoter, UV stabilizer, thickener, defoamer, pH adjuster, or combination. The content of each optional ingredient is sufficient to achieve its intended purpose, but preferably such an amount does not adversely affect the coating composition or the cured coating obtained therefrom. In the preferred embodiment of the present application, suitable additional additives include thickeners, surfactants, defoamers, bactericides, fungicides, or any combination thereof.

The additional additive is present in the range of about 0 to about 10% by weight, preferably in the range of about 0.1 to about 5% by weight, more preferably in the range of about 0.1 to about 1% by weight, relative to the total weight of the UV-LED curable coating composition. In one embodiment of the present application, the coating composition comprises 0.1 to about 10% by weight of the additional additive relative to the total weight of the coating composition. In particular, relative to the total weight of the coating composition, the amount of additional additive contained in the coating composition is from about 0.2% by weight, about 0.3% by weight, about 0.4% by weight, about 0.6% by weight, about 0.7% by weight, about 0.8% by weight or about 0.9% by weight to about 9.0% by weight, about 7.0% by weight, about 6.0% by weight, about 5.0% by weight, about 4.0% by weight, about 2.0% by weight or 1.0% by weight

In an embodiments of the present application, relative to the total weight of the coating composition the UV-LED curable coating composition comprises:
(a) 10-30% by weight of the at least one amine-modified polyether acrylate;
(b) 30-60% by weight of the at least one (meth)acrylate polymer different from (a);
(c) 0.5-2% by weight of the at least one multifunctional thiol compound;
(d) 3-6% by weight of the at least one acylphosphine oxide;
(e) 15-30% by weight of at least one reactive diluent;
(f) 0.5-2% by weight of at least one co-initiator; and
(g) 0.1-1% by weight of at least one additional additive comprising a thickener, a surfactant, a defoamer, a bactericide, or any combination thereof.

As an example of the surfactant, BYK-346 available from BYK Corporation may be used. As an example of the thickener, ACRYSOL RMTM-2020E can be used. As an example of the defoamer, BYK-088 available from BYK Corporation may be used.

The UV-LED curable coating composition according to the present application is curable when irradiated with light emitted by a light emitting diode (LED), wherein the wavelength of the light is from 340 nm to 420 nm, more preferably from 380 nm to 410 nm.

In the present application, the UV-LED curable coating composition can be prepared by a conventional method.

According to the present application, the UV-LED curable coating composition can be applied by conventional coating methods known to those of ordinary skill in the art. The coating methods include dip coating, spin coating, spray coating, curtain coating, brush coating, roll coating, and other coating methods known in the art.

The UV-LED curable coating composition according to the present invention is applied to a surface of a substrate and is irradiated by the light from a light emitting diode (LED) having a wavelength of about 340 nm to 420 nm, more preferably 380 nm to 410 nm, the coating composition can be subjected to photopolymerization so as to provide a cured coating on the surface of the substrate.

The present application provides a coating composition with higher reactivity under the LED-UV curing light source, in which a multifunctional thiol compound is introduced into the formulation to provide an excellent anti-oxidation effect on the surface while also using the “click” chemical reaction of the mercapto group and the double bond to increase the crosslinking degree of the coating, thereby improving the performance of the coating. On this basis, by adjusting the combination of the film-forming resin and the initiator, it is ensured that the coating composition will not yellow after curing, and the addition of the co-initiator further improves the reaction efficiency.

Therefore, the color difference value ΔE of the coating formed by curing the UV-LED curable coating composition according to the present application on a BYK white coating film test cardboard with the BYK white coating film test cardboard is less than 2.0, and Δb<1.5. The color difference value test is detailed in the example section.

Due to the above specific composition, the UV-LED curable coating composition according to the present application can be cured quickly and has high curing efficiency, wherein the curing energy required for curing the coating composition to form a coating layer does not exceed 2000 mJ/cm². The UV-LED curable coating composition according to the present application can provide good surface curing performance after curing. Compared with the conventional UV-LED curable coating composition, the UV-LED curable coating composition according to the present application can be cured quickly, and after curing, a coating having a comparable and even better yellowing resistance is obtained.

Therefore, the UV-LED curable coating composition according to the present application can be applied to a fast LED-UV curing line, used as a topcoat or primer, preferably as a topcoat, such as a finishing top-coat.

Therefore, the present application further provides an article comprising a substrate partially or fully coated with the UV-LED curable coating composition according to the present application. Those skilled in the art will select and determine a suitable material as the substrate according to actual needs.

The substrate may be a non-heat sensitive substrate such as glass, ceramic, fiber cement board or metal (e.g. aluminum, copper or steel), or may be a heat sensitive substrate. In view of the fact that the UV-LED curable coating composition of the present application can be cured with an LED radiation source having a low radiant energy, it is particularly suitable for providing a coating for a heat-sensitive substrate (preferably wood).

Suitable heat sensitive substrates include wood substrates such as solid wood, for example: hard wood, soft wood, plywood; veneer, particle board, low density fibre board, medium density fibreboard and high density fibreboard, OSB (Oriented Strand Board) wood laminates, chipboard and other substrate in which wood is an important constituent, such as for example foil covered wooden substrates, engineered wood, plastic modified wood, plastic substrates or wood plastic compounds (WPC); substrates with cellulosic fibres, for example cardboard or paper substrates.

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples are commercially available and used directly without further treatment.

### EXAMPLES

### Testing Methods

Adhesion

An adhesion test was performed to assess whether the coating was adhered to the coated substrate. The adhesion test was performed according to ASTM D 3359—Test Method B. Adhesion is usually classified as 0-5B, where 5B represents the optimal adhesion.

Gloss

This test was used to measure the gloss of the cured coating. A Sheen gloss meter was used to assess 60° Gloss according to ASTM D523.

Characterization of Yellowing Resistance

The UV-LED curable coating composition was bladed on the BYK white coating film test cardboard, with a coating amount of 10-12 g/m²; then cured under a 395 nm LED-UV light source with a curing energy of 1000-1500 mJ/cm². After curing, a color difference meter was used to test and calculate (according to the following formula) the color difference between the coated area and the original white cardboard.

ΔE=[(ΔL*)²+(Δa*)²+(Δb*)²]^{1/2}

in which, ΔL=Lₛₐₘₚₗₑ−L_{standard} (lightness difference); Δa=aₛₐₘₚₗₑ−a_{standard} (red/green difference); Δb=bₛₐₘₚₗₑ−b_{standard} (yellow/blue difference).
ΔE represents the total color difference;
Large ΔL means white, and small ΔL means black;
Large Δa means reddish, small Δa means greenish;
Large Δb means yellowish, small ΔL means blueish.

Solvent Resistance Test

A tolerance test of a solvent, such as methyl ethyl ketone or alcohol, was performed to assess the “curing” or cross-linking of the coating. This test was carried out as described in ASTM D 5402 93. After a certain number (usually 50) of double-rubs (i.e., one back-and forth motion), the integrity of the coating was determined. Solvent resistance was usually divided into grades of 0-5, where 5=coating is complete without scratches (best), 4=almost no coating scratches, 3=clear that the coating is scratched, 2=the gloss of the coating disappears due to scratches, 0=the coating is peeled off to reach the substrate (worst).

Characterization of Curing Effect

An abrasion resistance test was carried out to evaluate the degree of curing of the topcoat: press the dry linen with your thumb, and after the cured paint film surface is rubbed vigorously in both directions for 10 times, determine whether the coating surface is intact. The friction resistance test results were divided into 0-5 grades, where 5=the coating is intact and free of scratches (best), 4=almost no scratches on the coating are noticed, 3=it can clearly confirm that the coating is scratched, 2-0=The gloss of the coating disappears due to scratches.

Materials

The materials used are listed in Table 1 below.

TABLE 1
Materials and related information

| Components | Brief description |
|---|---|
| Eternal | Polyester acrylate, available from Changxing Materials |
| 63982 | Industry Co., Ltd. |
| PO 94F | Amine modified polyether acrylate, available from BASF |
| EO-TMPTA | Ethoxylated trimethylolpropane triacrylate, available from |
| | Tianjin Chemical Reagent Research Institute Co., Ltd. |
| DPGDA | Dipropylene glycol diacrylate, purchased from J&K |
| | Scientific Ltd. |
| TPO | 2,4,6-trimethylbenzoyl diphenyl phosphine oxide, available |
| | from BASF |
| BYK088 | Defoamer, available from BYK, Germany |
| Co-initiator | 1113C, available from Ketian, Zhongshan, China |

Preparation of UV-LED Curable Coating Composition

The UV-LED curable coating composition was formulated according to the ingredients shown in Table 2 below. Under stirring, the film-forming resin, multifunctional thiol compound, photoinitiator, co-initiator and additional additives were added to the reactive diluent to form a coating composition.

TABLE 2
Composition of UV-LED curable coating composition

| | | | | Comparative |
|---|---|---|---|---|
| Types | Ingredients | Example 1(wt %) | Example 2(wt %) | Example 1(wt %) |
| Film-forming | Eternal 63982 | 50% | 50% | 50% |
| resin | PO 94F | 20% | 20% | 20% |
| Reactive diluent | EO-TMPTA | 6% | 7.5% | 7.5% |
| | DPGDA | 15% | 15% | 15% |
| Multifunctional | pentaerythritol | 1.5% | 1.5% | 0 |
| thiol | tetrakis(3- | | | |
| | mercaptopropionate) | | | |
| Co-initiator | 1113C | 1.5 | 0 | 1.5 |
| Photoinitiator | TPO | 5.8% | 5.8% | 5.8% |
| Additional | BYK-088 | 0.2% | 0.2% | 0.2% |
| additive | | | | |

The coating composition thus formed was applied as a top-coat on a log-color cherry veneer MDF board (the board was pre-rolled with a UV-LED special primer and polished with 400-mesh sandpaper) to form a 15-micron coating. Then, the coating thus formed was subjected to UV-LED curing. The used LED ultraviolet lamp was purchased from Shenzhen Renwei Optoelectronics Co., Ltd., and its emission wavelength was 395 nm, and the power was 4500-5000 mW/cm².

The coating composition was cured at different linear speeds. During curing, the distance between the LED lamp and the sample was 5 cm. According to the method listed in the test method, the performance of the cured coating was measured, and the results were shown in Table 3.

TABLE 3
Coating performance

| | | | | | | | Comparative | |
|---|---|---|---|---|---|---|---|---|
| | | | | | | | Example 2 | |
| | | | | | Comparative | | (commercial | |
| | Example 1 | | Example 2 | | Example 1 | | product) | |
| Viscosity | 800-1200 | cps | 800-1200 | cps | 800-1200 | cps | 1500-2000 | cps |
| Required curing | 1800-2000 | mJ/m² | 2000-2500 | mJ/m² | 2000-2500 | mJ/m² | 2000-2500 | mJ/m² |
| energy | | | | | | | | |

| | | | | | |
|---|---|---|---|---|---|
| Curing | 10 m/min | 5 | 5 | 5 | 4-5 |
| effect | 15 m/min | 5 | 4-5 | 4-5 | 4 |
| | 20 m/min | 4-5 | 4 | 4 | 3 |

| | | | | |
|---|---|---|---|---|
| Gloss | >90° | >90° | >90° | >90° |
| Adhesion | 4-5B | 4-5B | 4-5B | 4-5B |
| Yellowing | 1.8 | 1.2 | 1.6 | 3.5 |
| resistance ΔE | | | | |
| Solvent resistance | 5 | 5 | 5 | 5 |

It can be seen from the above results that the UV-LED curable coating composition according to the present application achieved good curing and had excellent yellowing resistance. Moreover, the combination of a specific multifunctional thiol compound and a specific amine-modified polyether acrylate can not only inhibit surface oxygen inhibition, but also use the “click” chemical reaction of mercapto groups and double bonds to increase the crosslinking degree of the coating and thus to improve the performance of the coating. The addition of the co-initiator further improved the efficiency of the curing reaction, realized rapid curing, and reduced the required curing energy. The UV-LED curable coating composition according to the present application can obtain a coating with excellent surface properties in a short curing time.

All patents, patent applications and publications cited herein, as well as all disclosures of electronically available materials, are incorporated herein by reference. The foregoing detailed description and examples of the invention are only given for clear understanding. It cannot be understood as an unnecessary limitation. The application is not limited to the precise details shown and described, and variations obvious to those skilled in the art will be included in the application defined by the claims. In some embodiments, the present application illustratively disclosed herein can be implemented without any element not expressly disclosed herein.

While the invention has been described with respect to a number of embodiments and examples, those skilled in the art, having benefit of this disclosure, will appreciate that other embodiments can be devised which do not depart from the scope and spirit of the invention as disclosed herein.

What is claimed is:

1. A UV-LED curable coating composition, comprising:
(a) at least one amine-modified polyether acrylate;
(b) at least one (meth)acrylate polymer different from (a);
(c) at least one multifunctional thiol compound; and
(d) at least one acylphosphine oxide as a photoinitiator.

2. The UV-LED curable coating composition according to claim 1, wherein the at least one multifunctional thiol compound contains 3 or more at least three mercapto groups.

3. The UV-LED curable coating composition according to claim 1, wherein the (meth)acrylate polymer is selected from at least one of epoxy (meth)acrylate, polyurethane (meth)acrylate, polyester (meth)acrylate, polyether (meth)acrylate, and acrylate copolymer.

4. The UV-LED curable coating composition according to claim 1, wherein the coating composition further comprises a co-initiator, and wherein the co-initiator comprises one or more selected from alkylhydroxylamines, dimethylaminobenzoates and amine modified acrylate monomers or prepolymers, or combinations thereof.

5. The UV-LED curable coating composition according to claim 1, wherein the coating composition further comprises at least one reactive diluent.

6. The UV-LED curable coating composition according to claim 5, wherein the reactive diluent is selected from at least one of dipropylene glycol di(meth)acrylate, dipentaerythritol hexa(meth)acrylate, dipentaerythritol penta(meth)acrylate, 1,6-hexanediol di(meth)acrylate, (ethoxylated) trimethylolpropane tri(meth)acrylate, (propoxylated) trimethylolpropane tri(meth)acrylate, pentaerythritol tri(meth)acrylate, pentaerythritol tetra(meth)acrylate, and isobornyl (meth)acrylate, or combinations thereof.

7. The UV-LED curable coating composition according to claim 1, wherein, with respect to the total weight of the coating composition, the coating composition comprises:
(a) 10-30% by weight of the at least one amine-modified polyether acrylate;
(b) 30-60% by weight of the at least one (meth)acrylate polymer different from (a);
(c) 0.5-2% by weight of the at least one multifunctional thiol compound;
(d) 3-6% by weight of the at least one acylphosphine oxide;
(e) 15-30% by weight of at least one reactive diluent;
(f) 0.5-2% by weight of at least one co-initiator; and
(g) 0.1-1% by weight of at least one additional additive, comprising a thickener, a surfactant, a defoamer, a bactericide, or any combination thereof.

8. The UV-LED curable coating composition according to claim 1, which is used as a topcoat or primer, preferably as a topcoat.

9. The UV-LED curable coating composition according to claim 1, wherein the curing energy required for curing the coating composition to form a coating layer does not exceed 2000 mJ/cm2.

10. The UV-LED curable coating composition according to claim 1, wherein the color difference value ΔE of the coating formed by curing the coating composition on a BYK white coating film test cardboard with the BYK white coating film test cardboard is less than 2.0.

11. An article comprising a substrate partially or fully coated with a UV-LED curable coating composition according to claim 1.

12. The article of claim 11, wherein the substrate is one or more of wood, glass, ceramic, metal, plastic, paper, leather, fabric, and cementitious board, or combinations thereof.
